(19) United States
(12) Patent Application Publication
(10) Pub. No.: US 2007/0005649 A1
(43) Pub. Date: Jan. 4, 2007

(54) Contextual title extraction

(75) Inventors: Jian Wang, Beijing (CN); Fengping Zeng, Beijing (CN); Hua-Jun Zeng, Beijing (CN); Benyu Zhang, Beijing (CN); Zheng Chen, Beijing (CN); Chenxi Lin, Beijing (CN); Bing Sun, Beijing (CN)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/173,098

(22) Filed: Jul. 1, 2005

(51) Int. Cl. G06F 17/00

(52) U.S. Cl. 707/104.1

(57) ABSTRACT

The invention provides a method of creating contextual titles for web pages or documents. The method includes the extracting of phrases from a web page or document. The phrases are evaluated for use as contextual titles for the web page or document. The contextual title is utilized to access the web page or document by users.

### BACKGROUND

Web pages on the World Wide Web are becoming more complex to accommodate rapidly growing information needs. For example, many web browsers contain a variety of information such as headline news, sports scores, market information, shopping information, and entertainment news. In addition, users during the course of typical web browsing may open multiple web browser screens to view multiple different web pages.

The use of a tab web browser enables a user to more efficiently display multiple web pages. A tab web browser allows a user to switch between multiple web pages in a single window. Additionally, a tab web browser may also allow for faster web page viewing as users may not have to wait for web pages to open as the tab browser may already have the web pages available for viewing as one of the displayed tabs.

For example, FIG. 2 illustrates a tab web browser 200 which assists users in viewing several web pages at the same time. The tab web browser of FIG. 2 illustrates various web pages such as “Webmail Direct” 202, “CNN.com” 204, and “DallasNews.com” 206.

As a user opens additional web pages, the tabs displaying information related to each web page become smaller to allow additional accessed web pages to be displayed in the display area 208.

Tab web browsers, however, may only display a limited amount of information on the tab 210 for each web page. As a user opens multiple web pages using a tab browser, the tabs 210 for each web page become smaller and only a limited amount of information may be displayed on tab 210. The title for each tab 210 is important as the title information describes the represented web page to the user and allows a user to decide if they are interested in viewing the content of the web page.

Thus, it would be advancement in the art to provide a method in which the tabs of a tab web browser contain useful information concerning the content of the underling web page. Furthermore, the method should be transparent to a user and be useable on numerous types of documents with a minimal amount of effort.

### SUMMARY

The invention includes creation of contextual titles for web pages or other types of documents. The contextual titles provide meaningful titles for users based upon semantic content of the source document. The created contextual titles contain a limited amount of words to summarize contents of web pages or documents. The contextual titles may be utilized on tabs of a tab browser to provide concise and useful information to users.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a suitable computing system environment on which the invention may be implemented.

FIG. 2 illustrates a tab web browser displaying various web pages.

FIG. 3 illustrates a tab web browser displaying various web pages and a custom user's home page in accordance with an aspect of the invention.

FIG. 4 illustrates a method of creating a contextual title in accordance with an aspect of the invention.

FIGS. 5 and 6 illustrate an exemplary contextual title creation from a web page or document in accordance with a first aspect of the invention.

FIG. 7 illustrates another form of contextual title creation from a web page or document in accordance with another aspect of the invention.

FIG. 8 illustrates a further form of contextual title creation in accordance with an aspect of the invention.

FIG. 9 illustrates an additional form of contextual title creation in accordance with a further aspect of the invention.

### DETAILED DESCRIPTION

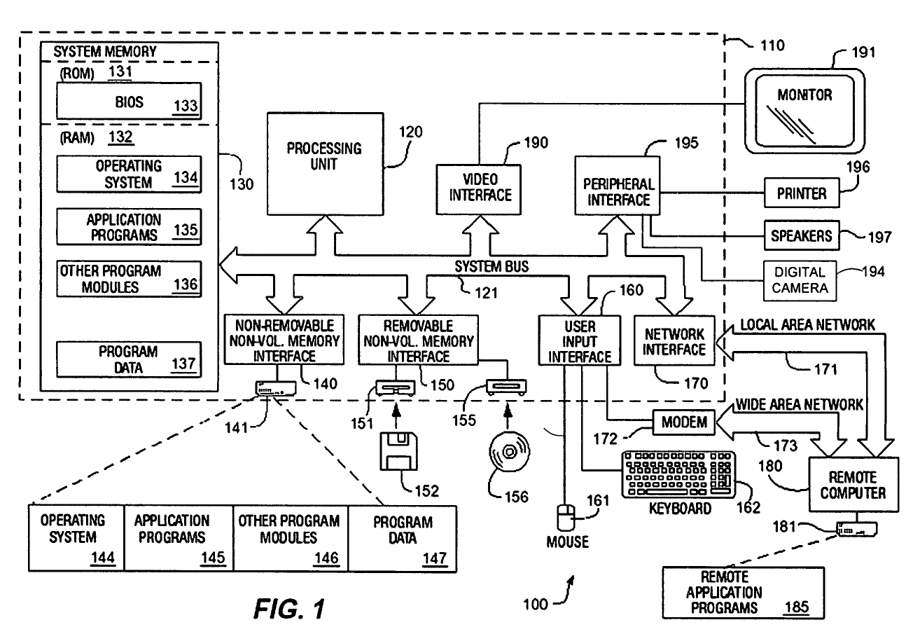

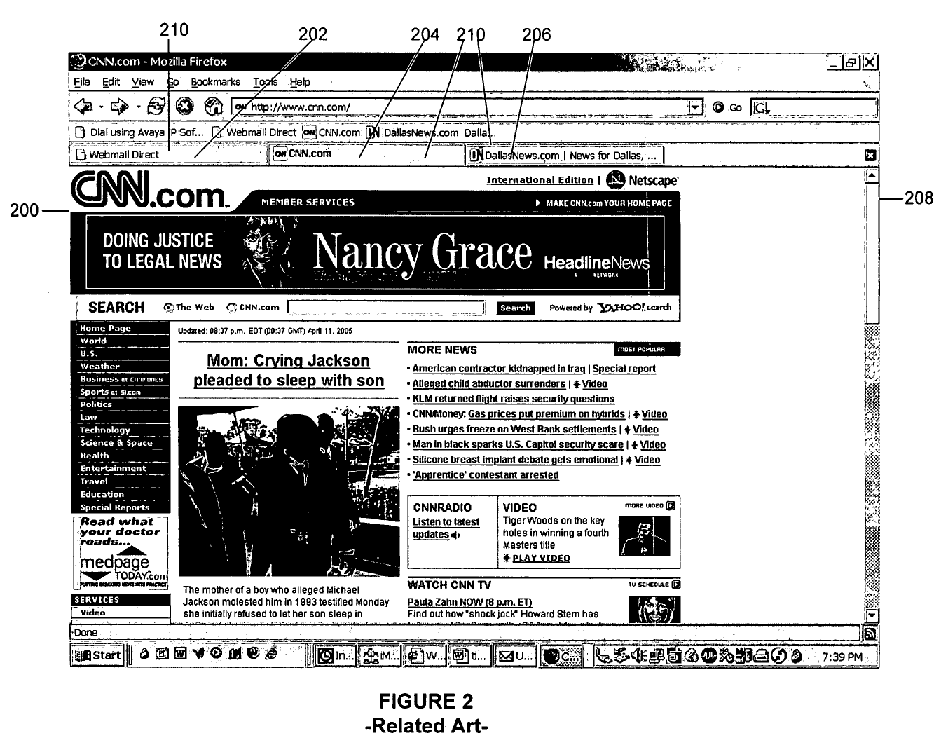

FIG. 1 illustrates an example of a suitable computing system environment 100 on which the invention may be implemented. Computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and wireless pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used. A peripheral interface 195 may interface to a video input device such as a scanner (not shown) or a digital camera 194, where output peripheral interface may support a standardized interface, including a universal serial bus (USB) interface.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that performs particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

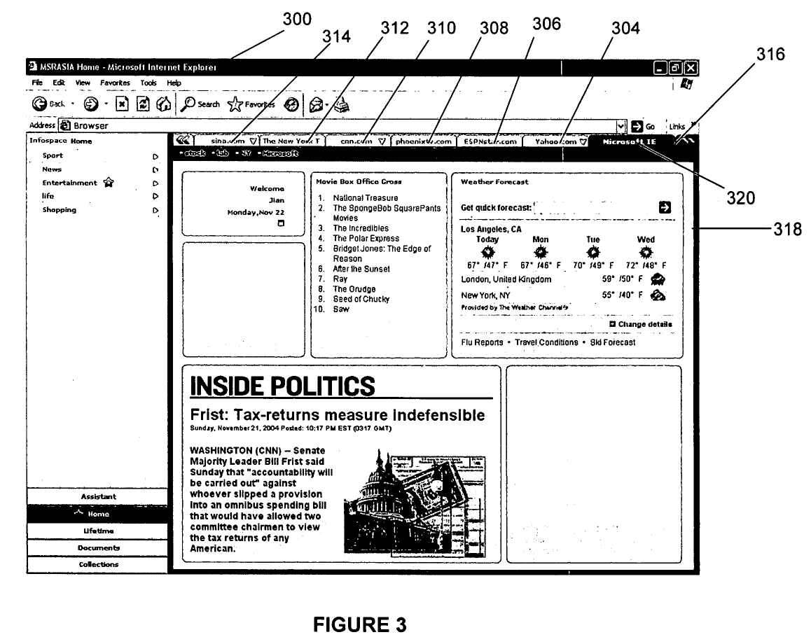

FIG. 3 illustrates a tab browser displaying various web pages and a user's custom web page in accordance with an aspect of the invention. In FIG. 3, a tab web browser 300 is utilized to display the various web pages and content. The tab browser 300 may display various web pages such as “Yahoo.com” 304, “ESPNstar.com” 306, “phoenixtv.com” 308, “cnn.com” 310, “The New York Times.com” 312, and “sina.com” 314. Those skilled in the art will realize that numerous other web pages may be displayed on tab browser 300 and those shown in FIG. 3 are meant to be exemplary. The web pages may be composed using hypertext mark-up language and/or an extensible markup language such as XML. Those skilled in the art will realize that other additional computer languages may be utilized in the creation of web pages.

As the number of opened web pages increases, the tabs representing each web page become smaller in order to view as many tabs as possible within the display area. Each instance of an additional web page being added to the tab browser may make it more difficult for a user to remember what content is being displayed on the various web pages. For example, tab 316 may display a web page representing a user's home page such as web page 318. The tab representing the user's home page may be named “Microsoft IE” 320. The title of the “Microsoft IE” 320 web page contains two words; however, titles of numerous other web pages contain numerous words which are not suitable for display on a tab of a tab browser due to limited display space. In addition, many titles used for tabs on a tab browser do not utilize titles having contextual content representing the web page. The use of a title having contextual content may assist a user in quickly determining the content of the web page without having to view or read the contents of the web page.

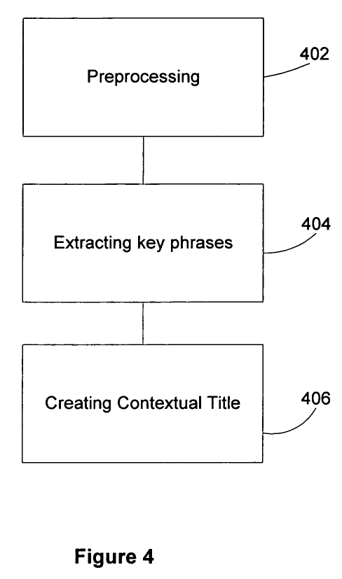

FIG. 4 shows an illustrative method for creating a contextual title for a web page or document. Referring to FIG. 4, a user identifies information such as a web page to be displayed by the user. The web page may be accessed by a tab web browser through the URL of the web page. For example, a user interested in headline news may be interested in viewing headline news as reported by CNN. The user may decide to access CNN's website through the user's tab web browser. In step 402, preprocessing of the selected web page may be completed prior to key phrase extraction. For example, preprocessing may include filtering of stop words or the conversion of capital letters to lowercase letters. The preprocessing may include removing the HTML tags in order to obtain pure text content. In addition, preprocessing may include tokenizing the pure text into separate words and removing stop words such as “a,” “the,” “to.” Finally, prepossessing may also include stemming to normalize words with same meaning (e.g. trimming the -s, -ing, -ed).

Next, in step 404 key phrase extraction from the web page or document may be initiated. The key phrase extraction may be executed on page content, URL, and/or title of the web page or document. Key phrase extraction may be based on frequency of a cited word or phrase being utilized in the web page or document.

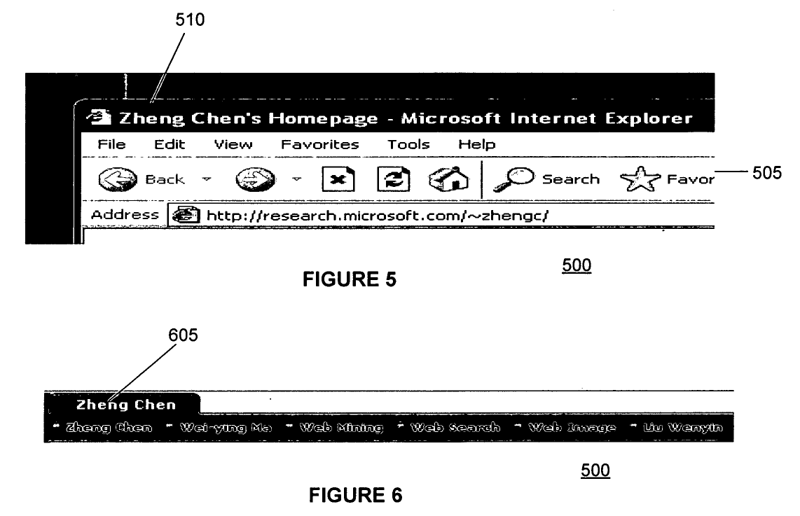

Furthermore, in step 406 the extracted key phrases may be utilized to create a contextual title. The contextual title may be displayed on the tabs of the tab web browser for the represented web page or document. FIGS. 5-9 illustrate various embodiments of the invention to determine a contextual title for a web page or document. The order of the presented embodiments in FIGS. 5-9 represent an order to determine which embodiments to use in case different results are obtained by various aspects of the invention. In one aspect of the invention, operations may be executed follows: 1) Extract important key phrases from title and page content; 2) Extract important key phrases from title combine with URL; 3) Extract important key phrases from URL combine with page content; 4) Extract important key phrase from page content; 5) Extract important key phrase from URL independently; and 6) Extract important key phrases from title. Each of the above listed six steps is optional. The more anterior operation may have a higher priority.

FIGS. 5 and 6 illustrate exemplary contextual title creation from a web page or document in accordance with an aspect of the invention. In FIG. 5, a user's web page 500 is displayed on a tab web browser 505. The title of the web page 500 may contain the user's name. For instance, the title of web page 500 may be “Zheng Chen's Home Page” 510.

In an aspect of the invention, key phrases are extracted from web page content and a web page title. Based on frequency, it may be determined that the words “Zheng Chen” are the most frequent words appearing in the page content or body of the web page 500. In addition, the words “Zheng Chen” may also appear in the title of web page 500. Based on the words being frequently used in the content and title of web page 500, the words “Zheng Chen” may be selected as the contextual title for web page 500. FIG. 6 shows the contextual title of “Zheng Chen” 605 being displayed on a tab of the tab web browser.

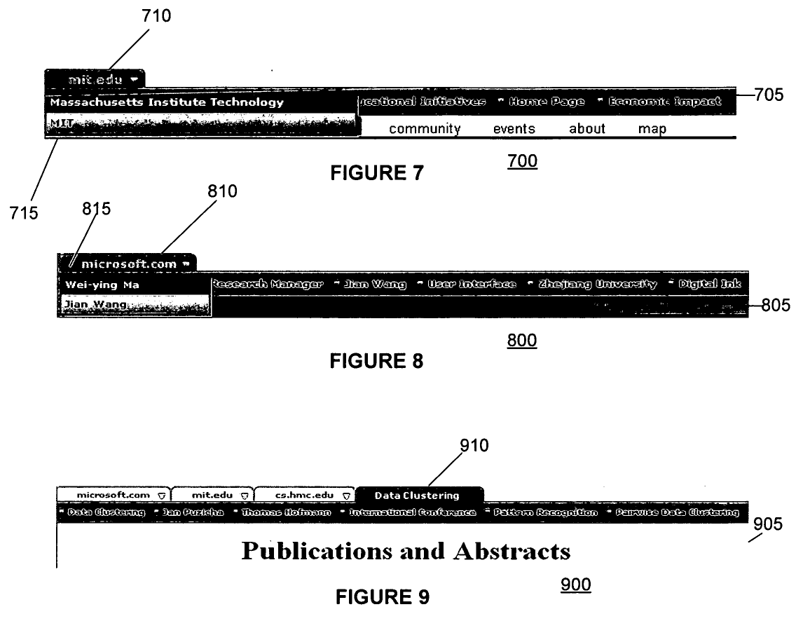

FIG. 7 illustrates another aspect of contextual title creation from a web page or document. In FIG. 7, a web page 700 is displayed on a tab web browser 705. The web page 700 may comprise information on an education institution such as Massachusetts Institute of Technology (MIT). The title of the web page may be mit.edu 710 as shown on tab 715 in FIG. 7. In an aspect of the invention, key phrases are extracted from web page content and combined with the title of the web page.

For example, based on frequency, it may be determined that the words “MIT” may be the most frequent words appearing in the page content or body of web page 700. In addition, the words “MIT” may also appear in the title of the web page 700. Based on the words being frequently used in the content and title of the web page 700, the words “MIT” may be selected as the contextual title for web page 700.

FIG. 8 illustrates a further form of contextual title creation in accordance with an aspect of the invention. In FIG. 8, a web page 800 is displayed on a tab web browser 805. The web page may comprise information from a user's personal home page. The web page 800 may not have a syntax title and instead use a default title such as “Microsoft.com” 810. In an aspect of the invention, key phrases are extracted from web page content and combined with the URL of the web page.

For example, based on frequency, it may be determined that the words “Jian Wang” may be the most frequent phrase appearing in the page content or body of web page 800. In addition, the phrase “Jian Wang” may also appear in the URL of the web page 800.

Based on the phrase being frequently used in the content of web page 800 and in the URL of the web page 800, the phrase “Jian Wang” may be determined as the contextual title of web page 800. The contextual title “Jian Wang” may be displayed on a tab 815 of tab web browser 805.

FIG. 9 illustrates an additional form of contextual title creation in accordance with a further aspect of the invention. In FIG. 9, a web page 900 is displayed on a tab web browser 905. The web page 900 may comprise information such as publications and abstracts of various articles or journals. The URL of web page 900 may not have a descriptive syntax title for use as a contractual title. In addition, web page 900 may have a URL which also does not contain and words or phrases which could represent the semantic content of web page 900. However, based on the frequency of words or phrases used in the page content, a contextual title of “Data Clustering” 910 may be used to represent the semantic content of web page 900.

In a further aspect of the invention, a single word or words comprising a URL may be best suited for describing content of a web page or document. Under this embodiment, the contextual title may be based on the word or phrase contained in the URL.

In another aspect of the invention, the most frequent words or words in a title may be used to describe the semantic content of a web page. This embodiment may be used as a default to determine a contextual title of a web page or document when the other above described embodiments do not produce a contextual title.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method of contextual title creation for a web page, the method comprising the steps of:
(a) accessing the web page through a tab browser;
(b) extracting key words from a title of the accessed web page;
(c) determining a contextual title for a tab of the tab browser, the contextual title based on the extracted key words; and
(d) displaying the contextual title on the tab of the tab browser for the accessed web page.

2. The method of claim 1, wherein the step of extracting key words further comprises extracting key words from page content of the accessed web page.

3. The method of claim 2, wherein the step of extracting key words further comprises extracting key words from a URL of the accessed web page.

4. The method of claim 1, wherein the accessed web page comprises hypertext mark-up language.

5. The method of claim 3, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the title and the page content.

6. The method of claim 3, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the title and the URL.

7. The method of claim 3, wherein the step of determining contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the URL and the page content.

8. The method of claim 3, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the page content.

9. The method of claim 3, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the URL.

10. The method of claim 3, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the title.

11. A computer-readable medium having computer-executable instructions for performing steps comprising:
(a) preprocessing a web page;
(b) accessing the web page through a tab browser;
(c) extracting key words from a title of the accessed web page;
(d) determining a contextual title for a tab of the tab browser, the contextual title based on the extracted key words; and
(e) displaying the contextual title on the tab of the tab browser for the accessed web page.

12. The computer-readable medium of claim 11, wherein the step of extracting key words further comprises extracting key words from page content of the accessed web page.

13. The computer-readable medium of claim 12, wherein the step of extracting key words further comprises extracting key words from a URL of the accessed web page.

14. The computer-readable medium of claim 13, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the title and the page content.

15. The computer-readable medium of claim 13, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the title and the URL.

16. The computer-readable medium of claim 13, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the URL and the page content.

17. The computer-readable medium of claim 13, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the page content.

18. The computer-readable medium of claim 13, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the URL.

19. The computer-readable medium of claim 13, wherein the step of determining a contextual title further comprises:
1) calculating frequency of the extracted key words from the title, the page content, and the URL of the accessed web page;
2) comparing the frequency of the extracted key words from the title, the page content, and the URL of the accessed web page; and
3) determining the contextual title based on the frequency of the extracted key words from the title.

20. A method of contextual title creation for a web page, the method comprising the steps of:
(a) preprocessing the web page;
(b) accessing the preprocessed web page through a tab browser;
(c) extracting key words from a title of the accessed web page;
(d) calculating frequency of the extracted key words from the title, the page content, and the URL of the accessed web page;
(e) comparing the frequency of the extracted key words from the title, the page content, and the URL of the accessed web page;
(f) determining a contextual title based on the frequency of the extracted key words from the title and the page content; and
(g) displaying the contextual title on a tab of the tab browser for the accessed web page.
